(19) United States
(12) Patent Application Publication
(10) Pub. No.: US 2006/0125615 A1
(43) Pub. Date: Jun. 15, 2006

(54) Vehicle accelerator and brake indicators

(76) Inventor: Won Moo Song, Haltom City, TX (US)

Correspondence Address: CARSTENS & CAHOON, LLP, P O BOX 802334, DALLAS, TX, 75380, US

(21) Appl. No.: 10/999,443

(22) Filed: Nov. 29, 2004

(51) Int. Cl. B60Q 1/22; B60Q 1/44; B60Q 1/50; B60Q 1/26

(52) U.S. Cl. 340/463; 340/467; 340/479; 340/469

(57) ABSTRACT

An improved accelerator and brake indicators for vehicles. Visual indicators of braking, coasting and acceleration are visible from the front, sides and rear of a vehicle. Such indicators may be used on any type of vehicle including cars, trucks, trailers, airplanes, motorcycles, bicycles, toy vehicles, etc. An accelerator indicator may be blue, green or any other color. An external accelerator indicator is not visible to an operator, and does not interfere with nighttime operation of vehicles. One or more indicator hues are chosen so as to be esthetically pleasing. Indicator design and placement are also chosen so as to be esthetically pleasing. Indicators are suitable for installation into any existing or future style of motor vehicle. Indicators may be positioned upon a motor vehicle in conventional and non-conventional locations. Preferentially, accelerator, brake, and running indicators comprise a housing including a reflective shell and one or more translucent lenses forming a sealed enclosure, a connector or socket, a removable light bulb or light emitting element, a means to electrically connect a socket to the brake light electrical system, and a means to electrically connect a socket to a sensor attached to the accelerator system of a motor vehicle.

### BACKGROUND

1. Technical Field

This invention relates generally to the field of safety signal light systems installed on a vehicle, and more particularly to a set of colored lights indicating the use of brakes and accelerator or the lack of use thereof.

2. Background of the Invention

Operating lights are used on all types of vehicles including, but not limited to, aircraft, cars, motorcycles, trucks, trains, bicycles, and toy vehicles. Brake lights of currently produced vehicles are typically red and are usually found only on the rear of a vehicle. Many vehicles also have red, yellow, orange or amber running lights. Such running lights are also on the front corners or sides of a vehicle. The intent of such lights is to provide higher visibility for vehicles.

FIG. 1 illustrates the placement of rear facing lights on a typical motor vehicle according to the prior art. The description of the present invention refers to an automobile, but those having ordinary skill in the art will appreciate that the invention may be adapted to other types of vehicles without departing from the invention. With reference to FIG. 1, red running lights and brake lights 102 are typically the largest and most prominent lights on the rear of a vehicle. Brake lights present brightly lit red lights while running lights generally present dimly lit red lights to observers. Many vehicles also have yellow, orange or amber running lights 104 visible from the rear of a vehicle. Such lights may also be used as turn signal indicators, or may work exclusively as turn signal indicators. Nearly all vehicles also have a white reverse drive indicator light 106, and many have an additional centrally located brake indicator light 108 mounted inside the vehicle's rear window.

Many states allow for the addition of other rearward facing lights excepting to white lights. It is a common practice for individuals to install purple, blue, green or other color of ornamental running lights. Such ornamental running lights may be attached and displayed under, on the sides or on a particular accessory of a vehicle.

On the rear of a vehicle, red vehicle brake lights are more brightly lit than red running lights. Brake lights provide a visual indication to following drivers that a vehicle's brakes have been engaged. Lights on the front of a vehicle are generally limited to headlights, marker or running lights, and turn signal lights. There are no indicators of the use of a vehicle's brakes or accelerator.

FIG. 2 shows a front oblique perspective view of a prior art motor vehicle. Headlights are generally white and have either a clear or white translucent protective lens covering an electric light emitting bulb. With reference to FIG. 2, one or more forward facing headlights 202 are mounted near each corner of a vehicle. One or more yellow, orange or amber running lights 204 are also mounted near each corner. Some vehicles also have optional running or fog lights 206 mounted under the bumper of the vehicle. Some vehicles also have side mounted running lights.

One problem exists when a following vehicle operator does not know whether the preceding operators of vehicles are using the vehicle's accelerator, or are coasting wherein the operator is using neither the accelerator nor brake. In 2003, 42,643 people were killed in the estimated 6,328,000 police-reported motor vehicle traffic crashes, and 2,889,000 people were injured. Providing faster and improved information regarding the operation of other vehicles in the path of a moving vehicle would substantially contribute to the safe operation of motor vehicles.

Another problem exists wherein observers and operators of other vehicles who are positioned in front of a vehicle do not know whether the operator of the vehicle has engaged its brake system. For example, a pedestrian crossing a street would know when an operator of a passing vehicle has applied his brakes in response to an obstacle in the operator's path. In another example, observers at an intersection would be able to determine if approaching vehicles have engaged their brakes. Sometimes it is difficult to judge whether the driver of an approaching vehicle intends to continue through a yellow semaphore light.

In 2003, the National Highway Traffic Safety Administration reported that in 2003, 4,749 pedestrians were killed in crashes with motor vehicles, and over 70,000 were injured. With a forward-facing brake light and accelerator light, many pedestrians can better use their own judgment before crossing the path of a vehicle. Currently, a pedestrian has few external indicators about the reaction or behavior of an oncoming vehicle operator other than a rough visual estimate of deceleration.

Accidents and fatalities can be reduced by presenting more noticeable and meaningful indicators mounted on the front and rear of a vehicle. Vehicle operators, pedestrians and other interested parties would benefit from such indicators. Prior art systems fail to adequately provide such accelerator and brake lights. The positioning of acceleration lights would be a natural extension of existing brake and running lights. Such a system would be able to indicate whether a motor vehicle operator is braking, accelerating or coasting. Such a system would be viewable from the front, sides and rear of a vehicle.

Few regulations exist in regard to mounting auxiliary brake lights on the front of a motor vehicle. Front facing brake lights have obvious advantages in terms of safety because they indicate to oncoming traffic the nature of a corrective driving action taken by the operator of an oncoming vehicle. It would be extremely desirable for motor vehicle operators and pedestrians to know what type of action a motor vehicle operator is taking, especially as an operator approaches an intersection. While current regulations do not address the need for forward- or side-facing brake lights, a number of patents have issued in an attempt to meet this and other similar needs to provide improved vehicle operation status indicators.

U.S. Pat. No. 6,663,271, issued to Giglio on Dec. 16, 2003, discloses a motor vehicle which has left and right front pillars having a brake light mounted in a recess so as to be visible from 360 degrees. However, such a brake light does not communicate the state of the acceleration pedal of a vehicle.

U.S. Pat. No. 5,798,691, issued to Kao on Aug. 25, 1998, discloses an accessory brake light system for the front of an automobile consisting of a plurality of LEDs mounted in an elongated housing. By flashing in different sequences, the LEDs can provide various warning signals to indicate braking conditions of the automobile, such as whether the vehicle is fully stopped, slowing down, or accelerating. Such a system is not visible from the rear of a vehicle.

U.S. Pat. No. 5,680,101 discloses a third rearward facing brake light. However, the placement of the third brake light is intended to prevent rear impact crashes by enabling a following vehicle to react more quickly to the front vehicles's braking. Such an indicator does not communicate the use of a vehicle's accelerator. Placement of an indicator solely in the front windshield of a vehicle would not be effective when a moving vehicle is observed from the side.

U.S. Pat. No. 5,594,415, issued to Ishikawa on Jan. 14, 1997, discloses a sensor and external indicator showing the degree of the operation of a vehicle's accelerator. An indicator showing the degree of the use of the brake pedal is also disclosed. Such indicators are shown both inside and outside of the vehicle. This patent also discloses the use of a blue lens over a rear facing light indicator, but does not claim such a blue or green lens in conjunction with the other features of the invention.

U.S. Pat. No. 5,379,198, issued to Zhang on Jan. 3, 1995, discloses a forward facing “courtesy lamp system” mounted above the dashboard of a vehicle which is installed into a housing located in the back surface of the rearview mirror, and which includes red and green lights. The red lights are coupled to the brake light system of the vehicle and are illuminated when the vehicle's brake pedal is depressed. The green lights are controlled by a manual switch, and are used by the driver to flash signals to pedestrians or other drivers. However, there is no disclosure of connecting these green lights to the accelerator of the vehicle.

U.S. Pat. No. 5,373,426, issued to O'Sullivan on Dec. 13, 1994, discloses a front-mounted vehicle brake light signal assembly which is electrically coupled to both the brake lights of the vehicle and a variable rate flasher. Upon depression of the brake pedal, the signal assembly illuminates or flashes to indicate the vehicle's deceleration. An accelerator indicator is not disclosed.

U.S. Pat. No. 5,255,165, issued to Cail on Oct. 19, 1993, discloses an after-market brake light assembly adapted for mounting on the inside surface of a vehicle's front windshield. The brake lights are configured as a series of lights in a column which is electrically coupled with a vehicle's conventional brake light system. An accelerator indicator is not disclosed.

U.S. Pat. No. 5,025,245, issued to Barke on Jun. 18, 1991, discloses a pedestrian signal system for automobiles which incorporates an alternating flasher into a main signal system of the vehicle via a relay. The flasher allows the driver to communicate to a pedestrian thus potentially reducing the number of vehicle-pedestrian collisions. Such auxiliary system is operated by a momentary pressure on a push button and by the application of pressure to the vehicle brake pedal. The system automatically shuts off after a predetermined time upon a release of the brake pedal.

Likewise, U. S. Pat. No. 4,940,962, issued to Sarokin on Jul. 10, 1990, discloses an auxiliary light system for automobiles where the lights are responsive to depression of a vehicle's brake pedal and the vehicle's speed. Although the lights are mounted on the front of a vehicle, the lights are located at the bottom of the front bumper rather than being “high mounted” and do not communicate the state of the accelerator pedal.

U.S. Pat. No.4,837,554, issued to Gianforcaro Jun. 6, 1989, discloses a vehicle signaling system comprising differently colored lights indicating the character of the motion of a vehicle. When a vehicle brake pedal is depressed and the car is in motion, red lights are flashed, whereas when the brake is depressed and the car is stopped green lights are flashed.

U.S. Pat. No. 4,682,146, issued to Friedman on Jul. 21, 1987, discloses a rearward facing indicator light system employing a single horizontal indicator which provides braking, parking, emergency flasher, and turn indications. The indicator is operated at partial intensity for a parking function and full intensity for a braking function.

U.S. Pat. No. 4,149,141, issued to Tanimura on Apr. 10, 1979, discloses a vehicle light assembly for indicating operating conditions of the vehicle to drivers of trailing vehicles. The invention comprises a rotatable lamp housing having green and amber lamps on one side thereof and a red lamp on another side. A position switch is associated with the accelerator pedal of the vehicle to light the green lamps when the accelerator pedal is depressed. A pressure switch provides a means for extinguishing the green lamps and lighting the amber lamps upon a decrease of the intake pressure of the engine below a predetermined level. A switch extinguishes the green and amber lamps, lights the red lamp, and energizes a rotating mechanism when braking the vehicle. This patent also discloses the use of a blue lamp in place of a green or amber one. However, there is no teaching of a forwardly visible indicator.

U.S. Pat. No. 3,665,392 issued to Annas on May 23, 1972, discloses a driver communication signal light mounted on the front windshield connected to the vehicle brakes for indicating to pedestrians and other drivers when the driver has applied his brake.

U.S. Pat. No. 3,634,792, issued to Blomenkamp on Jan. 11, 1972, discloses an apparatus for determining the acceleration and deceleration of a vehicle in which an electromechanical sensing device generates an output signal in response to the rotation of a shaft turning at a fixed ratio to the vehicle drive shaft. Electronic circuitry processes the signal of the sensing device for continuous monitoring of acceleration and deceleration on a meter, and for operating rear facing light signals indicating levels of acceleration and deceleration in a system that is integrated with conventional brake and reverse light systems.

U.S. Pat. No. 3,364,384 issued to Dankert on Jan. 16, 1968, discloses a signaling system for indicating a vehicle driver's actions. The system consists of a specially designed light mounted on the front of the vehicle and connected to sensors within. The light provides different colored visual signals depending upon whether the vehicle is at constant speed, accelerating, or decelerating.

U.S. Pat. No. 2,740,105 issued to Dorfman et al. on Mar. 27, 1956, discloses a red, amber and green light indicator system similar to that used as a street semaphore. The indicator system is designed to hang in the rear window of a car. The green light is lit when the accelerator is being used, the amber light is lit when the vehicle is coasting or slowing down, and the red light is lit when the brakes are being applied. There is no teaching to mount such a device in a forward facing position.

U.S. Pat. No. 2,190,123, issued to Page on Feb. 13, 1940, discloses a manually-activated indicator lamp box intended to be mounted in a vehicle, in the area of the rearview mirror, which indicates to pedestrians that the driver is yielding the right of way to pedestrians.

U.S. Pat. No. 1,553,959 issued to Pirkey on Sep. 15, 1925, discloses a manually-operated, switch-controlled turn and brake signal lamps for the front and rear of a vehicle.

Finally, published U.S. Patent Application 2002/0105423 submitted by Rast on Aug. 8, 2002 entitled “Reaction Advantage Anti-collision Systems and Methods” discloses a vehicle anti-collision system and method which provides drivers with additional time in which to react to significant roadway events. One implementation of Rast's system employs a brake pedal mounted sensor for determining how hard a driver is braking. Hard braking information is relayed to approaching drivers by means of the reverse lights of the vehicle. Other embodiments include the use of white or blue LED's. The disclosed system is only for rearward facing indicators.

Despite these and other prior patents and patent applications disclosing various brake light or acceleration/deceleration indicators, there remains a need in the transportation industry for an inexpensive light system which provides brake and accelerator indicators which communicate more accurately and effectively to observers the operating state of a vehicle. A need exists for such indicators which are visible from the front, side and rear of a vehicle. More specifically, there is a need for easily viewable and distinguishable indicators of the use of an automobile's accelerator and brakes. A further need exists for an aesthetically pleasing combination of color indicators which may be universally implemented in existing and manufactured vehicles.

### SUMMARY OF THE INVENTION

Improved indicators for the use of brakes and accelerator for vehicles are disclosed. Visual indicators of braking, coasting and acceleration are visible from the front, sides and rear of a vehicle. An accelerator indicator for a vehicle is externally visible, but is not visible to an operator, and does not interfere with vehicle operation at night or under low visibility conditions. One or more indicator colors are chosen so as to be aesthetically pleasing. Indicator design and placement are also chosen so as to be aesthetically pleasing. Improved indicators are suitable for installation into any type or style of vehicle. Such improved indicators may be installed at manufacture time. Indicators may be positioned upon a vehicle in conventional locations. Improved indicators may be retrofitted into an existing light system of an existing vehicle. In one embodiment, improved accelerator and brake indicators comprise a housing including a reflective shell and one or more transparent or translucent lenses forming a sealed enclosure, a socket, at least one light producing element, a means to electrically connect a socket to the vehicle's electrical system, a means to electrically connect a socket to a logic device and sensor which are attached to the vehicle's accelerator system, and a means to electrically connect a socket to a logic device and sensor which are attached to the vehicle's brake system. The sockets and reflective shell are disposed in the housing. The sockets each have at least one light producing element or light bulb inserted therein. The means to electrically connect a socket to the electrical system allows a brake light to illuminate when the vehicle brakes are applied. The means to electrically connect a socket to the accelerator system of the vehicle allows an accelerator light to be illuminated when the accelerator is used.

The invention accordingly comprises the advantages and features described more fully below, and the scope of the invention will be indicated in the claims. The objects of the present invention will become apparent in the following detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a rear view of a motor vehicle showing conventional brake, running and reverse indicator lights according to the prior art;

FIG. 2 is an oblique perspective view of a motor vehicle showing typical headlights, fog lights, turn signal lights and running lights according to the prior art;

FIG. 3 is an overhead view of a two-stop, four-way intersection;

FIG. 4A is an overhead view of a two lane road showing advantages of an improved accelerator indicator according to the present invention;

FIG. 4B is a perspective view of a two lane road showing advantages of an improved accelerator indicator according to the present invention;

FIGS. 5A-C are front oblique perspective views showing various embodiments of the present invention;

FIGS. 6A-D are rear views of a vehicle showing various embodiments of the present invention;

FIG. 7 is a side view of a vehicle showing side mounted brake and accelerator indicators attached to the front and rear regions of the vehicle, and a side mounted rearview mirror having attached brake and accelerator indicators, according to the present invention;

FIG. 7A is a close up view of a side mounted indicator on the front region of a vehicle as shown in FIG. 7;

FIG. 7B is a close up view of a side mounted indicator attached to, and forming part of, a side mounted rearview mirror as shown in FIG. 7; and,

FIG. 7C is a close up view of a side mounted indicator forming part of a vehicle's door handle as shown in FIG. 7.

### REFERENCE NUMERALS

102 brake light
104 yellow, orange or amber running light
106 reverse drive indicator light
108 centrally located brake indicator light
202 forward facing headlights
204 yellow, orange or amber running light
206 running light or fog light
302 stopped car near crosswalk
304 moving car
306 pedestrian
308 crosswalk
310 stopped car opposite crosswalk
320 forward facing brake indicator
322 forward facing accelerator indicator
402 lead car in left lane
404 lead car in right lane
406 first following car in left lane
408 first following car in right lane
410 second following car in the left lane
412 second following car in right lane
420 obstacle
422 high intensity rearward facing accelerator indicator
424 rearward facing brake indicator
426 low intensity rearward facing accelerator indicator
430 right lane
440 left lane
506 forward mounted accelerator indicator
508 low mounted, forward mounted accelerator indicator
610 rearward facing corner mounted accelerator indicator
612 rearward facing center mounted accelerator indicator
614 rearward facing trunk mounted accelerator indicator
702 accelerator indicator attached to side mounted rearview mirror
704 brake indicator attached to side mounted rearview mirror
712 accelerator indicator section of side mounted indicator unit
714 brake indicator section of side mounted indicator unit
720 side mounted indicator unit near front of vehicle
722 accelerator light element of accelerator indicator
724 brake light element of brake indicator
726 vehicle door handle
728 vehicle door key lock
730 side mounted indicator unit attached to side mounted rearview mirror
740 side mounted indicator unit as part of door handle apparatus
750 side mounted indicator unit near rear of vehicle

### DETAILED DESCRIPTION

While the invention is described below with respect to one or more preferred embodiments, other embodiments are possible. The concepts disclosed herein apply equally to other systems for externally indicating acceleration, deceleration and braking of an automobile or other vehicle through detecting the use of a vehicle's brakes and accelerator. A vehicle may include any motor vehicle, automobile, mass transportation vehicle, truck, tractor trailer, bus, school bus, commercial vehicle, commercial equipment, industrial equipment, military vehicle, snowmobile, jetski, scooter, motorcycle, minibike, bicycle, go-cart, moped, unmanned vehicle, toy car, toy ship, or toy aircraft. It will be readily apparent to those skilled in the art that various modifications, rearrangements, and substitutions can be made without departing from the spirit of the invention. The scope of the invention is defined by the claims appended hereto.

An externally visible accelerator indicator installed in a vehicle provides beneficial information to observers. One or more lights indicate whether an operator is using a vehicle's accelerator. In one embodiment, an indicator is off when the accelerator is in use, and lit when the accelerator is not in use. In another embodiment, an accelerator indicator is on or lit when the accelerator is in use, and off when the accelerator is not in use. In another embodiment, an accelerator indicator is dimly lit when the accelerator is in use, and brightly lit when the accelerator is not in use. In another embodiment, an accelerator indicator is brightly lit when the accelerator is in use, and dimly lit when the accelerator is not in use. In yet another embodiment, an indicator is illuminated for a fixed amount of time beginning from the point when a vehicle's accelerator is disengaged from use. The accelerator indicator has at least two intensities. “intensity” could be off, dimly lit, or brightly lit.

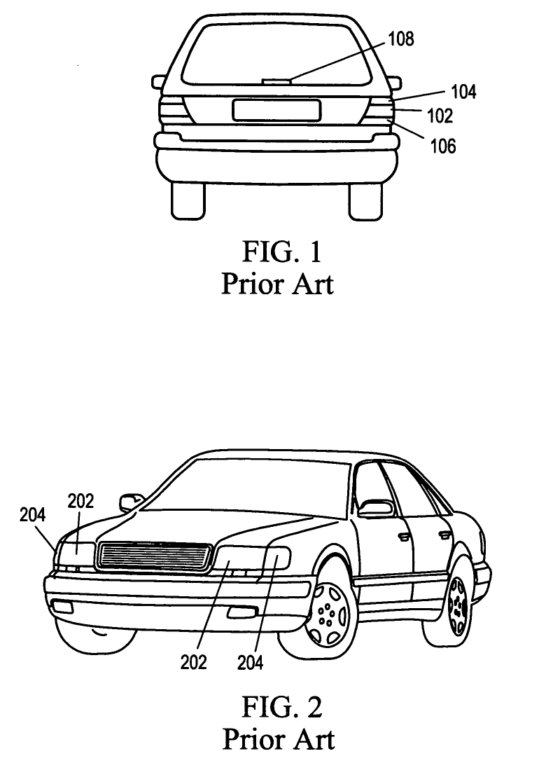

In a first embodiment, and with reference to FIG. 1, existing rear amber turn signals or running lights 104 comprise rearward facing accelerator indicators. Such amber lights 104, functioning as accelerator indicators, may be replaced by indicators of any color such as, but not limited to, blue or green indicators. With reference to FIG. 2, existing forward amber turn signals or running lights 204 comprise forward facing accelerator indicators. Similarly, such forwardly mounted amber lights 204 functioning as accelerator indicators, may be replaced by indicators of any color. Internally, such accelerator indicators, both forward or rearward, also contain an appropriate logic device (not shown) and sensor device (not shown) which allows such indicators to function when an accelerator is engaged or disengaged.

In another embodiment, an additional indicator functioning as an accelerator indicator is mounted in a rearward facing direction. Such a rearward facing accelerator indicator can be, but is not limited to being, mounted as part of or near a vehicle's taillights. In another embodiment, an accelerator indicator is mounted in any location in the rear region of a vehicle. In another embodiment, an accelerator indicator is mounted solely in a forward facing direction on the front region of a vehicle. In yet another embodiment, an accelerator indicator is mounted in a rearward facing direction on the rear region of a vehicle, and is separately mounted in forward facing direction on the front region of a vehicle.

In another embodiment, an accelerator indicator is solely mounted on the side of a vehicle. Such a side mounted accelerator indicator is visible from a side, generally forward and generally rearward directions relative to the vehicle. In another embodiment, one or more accelerator indicators are mounted on the side, forward and rearward regions of a vehicle. In such embodiments, an accelerator indicator may form part of a turn indicator or indicator system.

In another embodiment, a brake indicator is mounted in a rearward facing direction on the rear region of a vehicle, and a brake indicator is separately installed in a forward facing direction on the front region of a vehicle. In another embodiment, a brake indicator is mounted on the side region of a vehicle. Such a side mounted accelerator indicator is visible from a side, generally forward and generally rearward directions relative to the vehicle. A brake indicator may be mounted in the same or adjacent housing to a side mounted accelerator indicator. A brake indicator may be red. Alternatively, a brake indicator may be red or any other color. A brake indicator may be combined with an accelerator indicator to signal that a driver is applying a vehicle's brakes. Such use of an colored or colorless indicators makes it easier for observers to notice that a vehicle is stopping.

Such accelerator and brake indicators may be illuminated in a variety of intensities including, but not limited to, low, medium and high intensity states, or lower, equal and higher states relative to running lights, emergency lights, conventional brake lights, or headlights. The states of such indicators may be of any intensity, duration, or pattern. One state of a brake indicator is of a constant intensity for a predetermined amount of time as either the brake or accelerator is engaged. Likewise, one state of an accelerator indicator is of a constant intensity for a predetermined amount of time as either the brake or accelerator is engaged.

An indicator may be illuminated for any length of time and may be extinguished upon the occurrence of another event. A pattern may be of any repeated or predictable sequence of short or long illuminations of the indicators. A pattern also may be any combination of the use of one or more of such indicators illuminated in a repeatable sequence. A pattern may be an illumination, blinking or flashing sequence. A brake indicator may function as an accelerator indicator. In one embodiment, a brake indicator flashes indicating the engagement or disengagement of an accelerator.

The use of accelerator and brake indicators together may indicate a turn of a vehicle. Further, improved accelerator and brake lights may be programmed, or contain a pre-programmed logic component, to provide more meaningful communication in emergency situations. For example, police already use emergency lights which illuminate or flash red and blue in an alternating pattern. It would be beneficial for any stopped or operating vehicle to have an indicator system which would provide more meaningful, brighter or increased number of emergency lights. Improved accelerator and brake indicators according to the present invention, being mounted on the front, sides, or rear of a vehicle, would provide such ability and benefits.

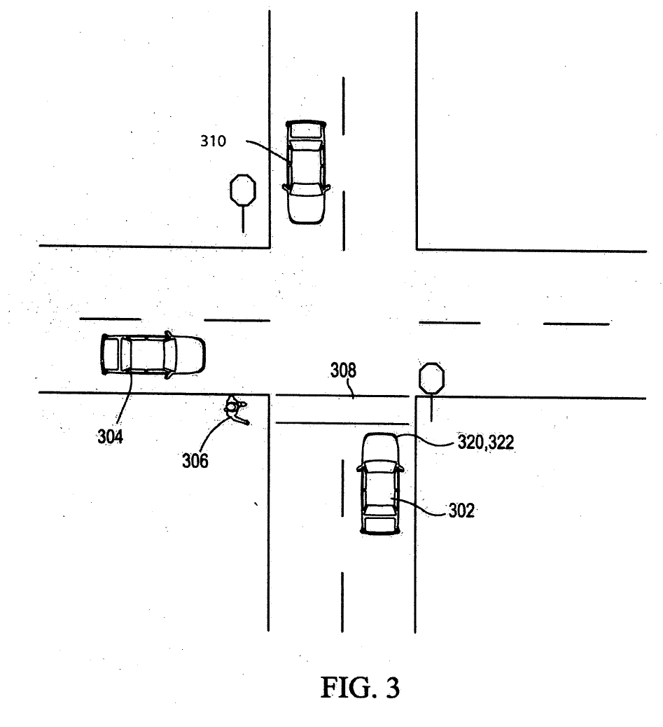

Another set of benefits of improved accelerator and brake indicators can be seen by reference to a typical driving scenario as shown in FIG. 3. With reference to FIG. 3, two cars 302, 310 are stopped opposite each other at stop signs at a two-way stop, four-way intersection. The driver of an approaching vehicle 304 is able to see forward facing brake lights 320 and forward facing accelerator lights 322 of the car on the driver's right 302. The approaching driver is able to see that the car on the driver's right 302 does not have its accelerator engaged and has its brakes engaged. Likewise, the driver of the approaching vehicle 304 is able to see forward facing brake lights 320 and forward facing accelerator lights 322 of the car on the driver's left 310. If either or both of the cars on the driver's right 302 and the driver's left 310 were accelerating into the intersection, the driver would see the lack of forward facing brake lights 320 and would see forward facing accelerator lights 322.

Similarly, a pedestrian 306 waiting to cross the street in front of the stopped cars 302, 310 at stop signs in a crosswalk 308 would be able to verify that the stopped cars 302, 310 were actually stopped by seeing forward facing brake lights 320 and the lack of forward facing accelerator lights 322. A pedestrian 306 also would be able to determine that the driver of the approaching car 304 has not engaged the brakes by noticing the lack of forward facing brake lights 320 and would see a forward facing accelerator indicator 322.

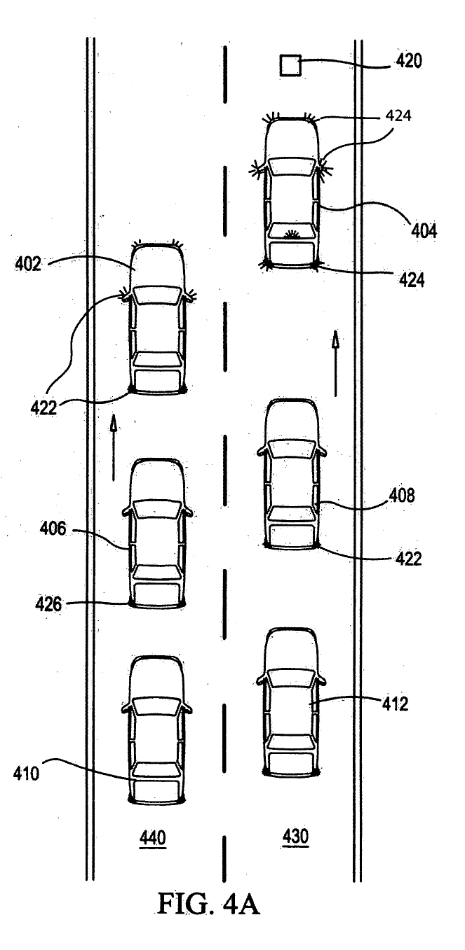

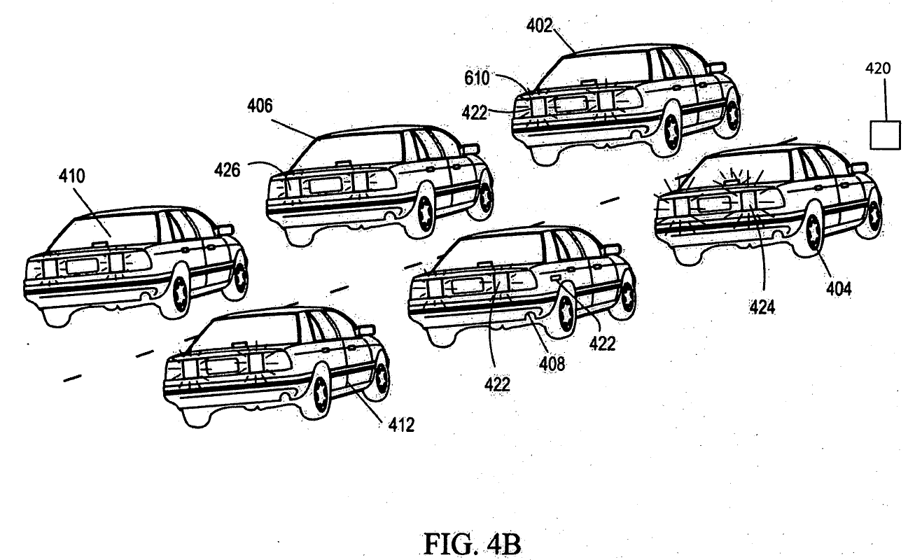

Additional benefits of improved brake and accelerator indicators can be seen by reference to another typical driving scenario as shown in FIG. 4A and FIG. 4B. Even though reference is made to “car”, a car may be any vehicle. In this scenario, the lead car in the right lane 404 is decelerating by applying the vehicle's brakes, and is displaying illuminated brake lights 424 through improved brake indicators mounted at the front, side and rear of the vehicle in response to an obstacle in the road 420. In a preferred embodiment, there is no use of accelerator lights when vehicle brakes are engaged.

The driver of the lead car in the left lane 402, also seeing the obstacle 420 in the road, and seeing the improved brake lights 424 of the lead car 404 in the right lane 430, has already disengaged the accelerator and is watching for changing road conditions without applying the brakes. The lead car 402 in the left lane 440, while coasting without the use of the accelerator, is displaying one or more illuminated rearward facing, side facing, and forward facing accelerator indicators 422. With reference to FIG. 4B, an observer may be able to see accelerator or brake indicators which are mounted to, or form part of, a rearview mirror on a side of a vehicle. In one embodiment, an illuminated rearward facing accelerator indicator 422 is intensely or brightly lit in response to the driver disengaging the accelerator. In another embodiment, such indicator 422 is dimly or less brightly lit, or is not lit.

Further, and with reference to FIG. 4A, the driver of the first following car 408 in the right lane 430, upon seeing the brake lights 424 of the leading car 404, disengages the accelerator. At this time, accelerator indicator lights, which may be located on the front, sides and rear of the first following 408, are changed from a dimly lit to a brightly lit state 422. Such change signals to all viewers that the first following car 408in the right lane 430 could be transitioning to a braking state. Such advanced notice of potential braking by the first following car 408 would give all viewers more time in which to take corrective action.

The driver of the first following car 406 in the left lane 440, without necessarily seeing the obstacle solely in the right lane 430, has improved information from the accelerator indicators 422 and brake light indicators 424 on the leading cars 402, 404 and the nearest adjacent car 408. Armed with this information, this driver perceives that perhaps he will not have to engage his brakes since the lead car 402 in the left lane 440 has not engaged his brakes, and perceives that just the right lane 430 is slowing. The driver of the first following car 406 in the left lane 440 thus has not disengaged the accelerator and has not engaged the brakes, and the accelerator lights are thus still in a dimly lit state 426.

With reference to FIG. 4A and FIG. 4B, the driver of the second following car 412 in the right lane 430 also has improved information from the four preceding cars 402, 404, 406, 408. Specifically, the driver can perceive the accelerator indicators of the two preceding cars 402, 406 in the left lane 440 such that the leading car 402 is coasting and the first following car 406 is still using the accelerator. The indicators may be located on the front, sides or rear sections of a vehicle. Also, this driver perceives that the leading car 404 in the right lane 430 is braking and the first following car 408in the right lane 430 may be about to brake. Thus, this driver can perceive that the traffic in the right lane 430 is about to dramatically slow and that it may be preferable to transfer to the left lane 440 since the traffic in the left lane 440 is flowing more quickly. Similarly, the driver of the second following car 410 (not shown in FIG. 4B) in the left lane 440 has improved information from the five preceding cars 402, 404, 406, 408, 412. Specifically, the driver can perceive the accelerator indicators of the two preceding cars 402, 406 in the left lane 440, and the three preceding cars 404, 408, 412 in the right lane 430. This driver perceives that the traffic in the right lane 430 is about to dramatically slow, and that it may be preferable to remain in the left lane 440 since the traffic in the left lane 440 is flowing more quickly. Additionally, the driver of the second following car 410 may decide to coast in response to the brightly lit accelerator lights of the leading car 402. By perceiving how other drivers are using the accelerator, the driver of the second following car 410 has more information with which to make driving decisions and has more time in which to take corrective action.

Persons having ordinary skill in the art will appreciate that information from accelerator and brake indicators allows drivers and observers to make more informed decisions. Such additional information from preceding cars provides an improved safety system for drivers in many driving scenarios including providing more response time in which to take corrective action due to changing road conditions. Such improved information may save lives and reduce the number of vehicle accidents.

Such additional information allows drivers to coast instead of brake in certain driving scenarios. As measured over time, such additional information reduces the amount of stop and go operation of vehicles, reduces the amount of gasoline consumed in a single vehicle and collectively over all vehicles, reduces vehicle brake wear, and reduces the amount of exhaust released to the environment.

There are innumerable foreseeable embodiments of an accelerator indicator. Several physical embodiments are presented here. In one embodiment, an accelerator indicator comprises a housing, a reflective shell which is attached to a translucent lens and which forms a sealed enclosure, and a light bulb removably inserted into an electrical socket. The socket is coupled to a logic device and a vehicle's electrical system by wires such that an attached indicator emits light when energized. For example, a socket and light bulb for an accelerator indicator would be as inexpensive and as easy to manufacture and install as conventional taillights, running lights, fog lights and headlights.

Further, in each embodiment, it is implicit that there is a sensing device and logic device associated with each external or internal accelerator and brake indicator. It will be obvious to those in the art that an improved accelerator indicator or brake indicator as described herein would not function without such components. Such sensing and logic devices are hereby implicitly incorporated.

In one embodiment, an accelerator indicator comprises an existing housing and existing reflective shell combined with an existing translucent lens and a new electrical socket attached to the existing housing. An accelerator may thus be retrofitted into an existing vehicle with the addition of a new electrical socket and an additional sensing and logic device attached to a vehicle's accelerator system.

In another alternative, an accelerator indicator may use existing turn signal indicators and running lights with the addition of an additional sensing device and logic device attached to a vehicle's accelerator system. In a further alternative, an accelerator indicator comprises an LED, LCD, or other light emitting device instead of a conventional or halogen light bulb.

In another embodiment, an accelerator indicator is dimly lit or dimly glows when the accelerator is engaged. When the accelerator indicator is disengaged, the accelerator indicator is continuously and brightly lit until such time as the occurrence of a measurable event. Such event includes, but is not limited to, when the accelerator is re-engaged, the brakes are engaged, a timer expires, the electrical system of the vehicle is turned off, the light system of the vehicle is turned off, and the steering wheel is turned a predetermined amount. In an alternative embodiment, an accelerator indicator is off when the accelerator is engaged, and the indicator is on, lit or glows when the accelerator is disengaged. In a further alternative embodiment, an accelerator indicator is on, lit or glows when the accelerator is engaged, and the indicator is off when the accelerator is disengaged.

Table 1 illustrates several various alternative modes of operation of improved accelerator and brake indicators according to the present invention. With reference to Table 1, in case 1, an accelerator indicator may be off, illuminating at a first intensity or level (level 1), or illuminating at a second level (level 2). In one embodiment, level 1 is less intense than level 2. In case 2, a braking indicator is illuminated when a vehicle's brake is engaged. In case 3, when a vehicle's accelerator is engaged, an accelerator indicator may be off, illuminating at a first intensity or level (level 1), or illuminating at a second level (level 2). In case 4, a brake indicator is illuminated and an accelerator indicator may be in any of the states. In another embodiment, a brake indicator may also illuminate at a first and a second intensity or level.

For a given set of modes of operation for a set of indicators, the state of the accelerator indicator in case 3 or case 4 cannot be the same state as the state of the accelerator indicator in case 1. For example, an accelerator indicator could change from level 2 to level 1, but could not remain in level 2 when going from case 3 to case 1, and vice versa. Otherwise, all other permutations of the state of an accelerator indicator are permitted. Other levels or intensities are possible. Such modes in Table 1 illustrate that an observer is likely to notice a transition from one state of an indicator to another. For example, for an operator who disengages the accelerator, an observer is likely to see a change in accelerator indicator intensity, such as, but not limited to, the accelerator indicator going from level 2 to level 1.

TABLE 1
Alternative Modes of Operation of Improved
Accelerator and Brake Indicators

| | | | | Brake | Acceler- |
|---|---|---|---|---|---|
| | | | | Indi- | ator |
| Case | Brake | Accelerator | Status | cator | Indicator |
| 1-1 | Disengaged | Disengaged | Coasting | Off | Off, |
| | | | | | Level 1, |
| | | | | | Level 2 |
| 1-2 | Engaged | Disengaged | Braking | On | Off, |
| | | | | | Level 1, |
| | | | | | Level 2 |
| 1-3 | Disengaged | Engaged | Accelerating | Off | Off, |
| | | | | | Level 1, |
| | | | | | Level 2 |
| 1-4 | Engaged | Engaged | Emergency | On | Off, |
| | | | | | Level 1, |
| | | | | | Level 2 |

Likewise, for a brake having two levels of illumination, there are many more permutations of illumination of a brake indicator in combination with an accelerator indicator. Table 2 illustrates the various permutations possible for such a system.

TABLE 2
Alternative Modes of Operation of Improved
Accelerator and Brake Indicators

| | | | | Brake | Acceler- |
|---|---|---|---|---|---|
| | | | | Indi- | ator |
| Case | Brake | Accelerator | Status | cator | Indicator |
| 2-1 | Disengaged | Disengaged | Coasting | Off, Level | Off, |
| | | | | 1, Level 2 | Level 1, |
| | | | | | Level 2 |
| 2-2 | Engaged | Disengaged | Braking | Level 1, | Off, |
| | | | | Level 2 | Level 1, |
| | | | | | Level 2 |
| 2-3 | Disengaged | Engaged | Acceler- | Off, Level | Off, |
| | | | ating | 1, Level 2 | Level 1, |
| | | | | | Level 2 |
| 2-4 | Engaged | Engaged | Emergency | Level 1, | Off, |
| | | | | Level 2 | Level 1, |
| | | | | | Level 2 |

Table 3 through Table 12 illustrate certain preferred modes of operation of improved accelerator and brake indicators according to the present invention, although other operation modes are possible. Table 3 and Table 4 show the status of the brake and accelerator indicators for a vehicle wherein a binary (on/off) indicator is used for both a brake indicator and an accelerator indicator. Table 5 and Table 6 show the status of brake and accelerator indicators for a vehicle wherein a binary or on/off indicator is used for the brake indicator and a two level indicator is used for the accelerator indicator. Table 7 and Table 8 show the status of brake and accelerator indicators for a vehicle wherein a two level indicator is used for the brake indicator and a binary or on/off indicator is used for the accelerator indicator. Table 9 through Table 10 show the status of brake and accelerator indicators for a vehicle wherein a two level indicator is used for the brake indicator and a two level indicator is used for the accelerator indicator. For an emergency status where both brake and accelerator are engaged, all permutations are possible.

TABLE 3
One Level of Brake Indicator and One
Level of Accelerator Indicator

| | | | | Brake | Acceler- |
|---|---|---|---|---|---|
| | | | | Indi- | ator |
| Case | Brake | Accelerator | Status | cator | Indicator |
| 3-1 | Disengaged | Disengaged | Coasting | Off | Off |
| 3-2 | Engaged | Disengaged | Braking | On | Off |
| 3-3 | Disengaged | Engaged | Acceler- | Off | On |
| | | | ating | | |
| 3-4 | Engaged | Engaged | Emergency | On | Off, On |

TABLE 4
One Level of Brake Indicator and One
Level of Accelerator Indicator

| | | | | Brake | Acceler- |
|---|---|---|---|---|---|
| | | | | Indi- | ator |
| Case | Brake | Accelerator | Status | cator | Indicator |
| 4-1 | Disengaged | Disengaged | Coasting | Off | On |
| 4-2 | Engaged | Disengaged | Braking | On | Off |
| 4-3 | Disengaged | Engaged | Acceler- | Off | Off |
| | | | ating | | |
| 4-4 | Engaged | Engaged | Emergency | On | Off, On |

TABLE 5
One Level of Brake Indicator and Two
Levels of Accelerator Indicator

| | | | | Brake | Acceler- |
|---|---|---|---|---|---|
| | | | | Indi- | ator |
| Case | Brake | Accelerator | Status | cator | Indicator |
| 5-1 | Disengaged | Disengaged | Coasting | Off | Level 1 |
| 5-2 | Engaged | Disengaged | Braking | On | Off |
| 5-3 | Disengaged | Engaged | Acceler- | Off | Level 2 |
| | | | ating | | |
| 5-4 | Engaged | Engaged | Emergency | On | Off, |
| | | | | | Level 1, |
| | | | | | Level 2 |

TABLE 6
One Level of Brake Indicator and Two
Levels of Accelerator Indicator

| | | | | Brake | Acceler- |
|---|---|---|---|---|---|
| | | | | Indi- | ator |
| Case | Brake | Accelerator | Status | cator | Indicator |
| 6-1 | Disengaged | Disengaged | Coasting | Off | Level 2 |
| 6-2 | Engaged | Disengaged | Braking | On | Off |
| 6-3 | Disengaged | Engaged | Acceler- | Off | Level 1 |
| | | | ating | | |
| 6-4 | Engaged | Engaged | Emergency | On | Off, |
| | | | | | Level 1, |
| | | | | | Level 2 |

TABLE 7
Two Levels of Brake Indicator and
One Level of Accelerator Indicator

| | | | | Brake | Acceler- |
|---|---|---|---|---|---|
| | | | | Indi- | ator |
| Case | Brake | Accelerator | Status | cator | Indicator |
| 7-1 | Disengaged | Disengaged | Coasting | Level 1 | Off |
| 7-2 | Engaged | Disengaged | Braking | Level 2 | Off |
| 7-3 | Disengaged | Engaged | Acceler- | Off | On |
| | | | ating | | |
| 7-4 | Engaged | Engaged | Emergency | Level 1, | Off, On |
| | | | | Level 2 | |

TABLE 8
Two Levels of Brake Indicator and
One Level of Accelerator Indicator

| | | | | Brake | Acceler- |
|---|---|---|---|---|---|
| | | | | Indi- | ator |
| Case | Brake | Accelerator | Status | cator | Indicator |
| 8-1 | Disengaged | Disengaged | Coasting | Level 1 | Off |
| 8-2 | Engaged | Disengaged | Braking | Level 2 | Off |
| 8-3 | Disengaged | Engaged | Acceler- | Level 1 | On |
| | | | ating | | |
| 8-4 | Engaged | Engaged | Emergency | Level 1, | Off, On |
| | | | | Level 2 | |

TABLE 9
Two Levels of Brake Indicator and Two
Levels of Accelerator Indicator

| | | | | Brake | Acceler- |
|---|---|---|---|---|---|
| | | | | Indi- | ator |
| Case | Brake | Accelerator | Status | cator | Indicator |
| 9-1 | Disengaged | Disengaged | Coasting | Level 1 | Level 1 |
| 9-2 | Engaged | Disengaged | Braking | Level 2 | Off |
| 9-3 | Disengaged | Engaged | Acceler- | Level 1 | Level 2 |
| | | | ating | | |
| 9-4 | Engaged | Engaged | Emergency | Level 1, | Off, |
| | | | | Level 2 | Level 1, |
| | | | | | Level 2 |

TABLE 10
Two Levels of Brake Indicator and Two
Levels of Accelerator Indicator

| | | | | Brake | Acceler- |
|---|---|---|---|---|---|
| | | | | Indi- | ator |
| Case | Brake | Accelerator | Status | cator | Indicator |
| 10-1 | Disengaged | Disengaged | Coasting | Level 1 | Level 1 |
| 10-2 | Engaged | Disengaged | Braking | Level 2 | Level 1 |
| 10-3 | Disengaged | Engaged | Acceler- | Level 1 | Level 2 |
| | | | ating | | |
| 10-4 | Engaged | Engaged | Emergency | Level 1, | Off, |
| | | | | Level 2 | Level 1, |
| | | | | | Level 2 |

TABLE 11
Two Levels of Brake Indicator and Two
Levels of Accelerator Indicator

| | | | | Brake | Acceler- |
|---|---|---|---|---|---|
| | | | | Indi- | ator |
| Case | Brake | Accelerator | Status | cator | Indicator |
| 11-1 | Disengaged | Disengaged | Coasting | Level 1 | Level 2 |
| 11-2 | Engaged | Disengaged | Braking | Level 2 | Off |
| 11-3 | Disengaged | Engaged | Accelerating | Level 1 | Level 1 |
| 11-4 | Engaged | Engaged | Emergency | Level 1, | Off, |
| | | | | Level 2 | Level 1, |
| | | | | | Level 2 |

TABLE 12
Two Levels of Brake Indicator and Two
Levels of Accelerator Indicator

| | | | | Brake | Acceler- |
|---|---|---|---|---|---|
| | | | | Indi- | ator |
| Case | Brake | Accelerator | Status | cator | Indicator |
| 12-1 | Disengaged | Disengaged | Coasting | Level 1 | Level 2 |
| 12-2 | Engaged | Disengaged | Braking | Level 2 | Level 2 |
| 12-3 | Disengaged | Engaged | Accelerating | Level 1 | Level 1 |
| 12-4 | Engaged | Engaged | Emergency | Level 1, | Off, |
| | | | | Level 2 | Level 1, |
| | | | | | Level 2 |

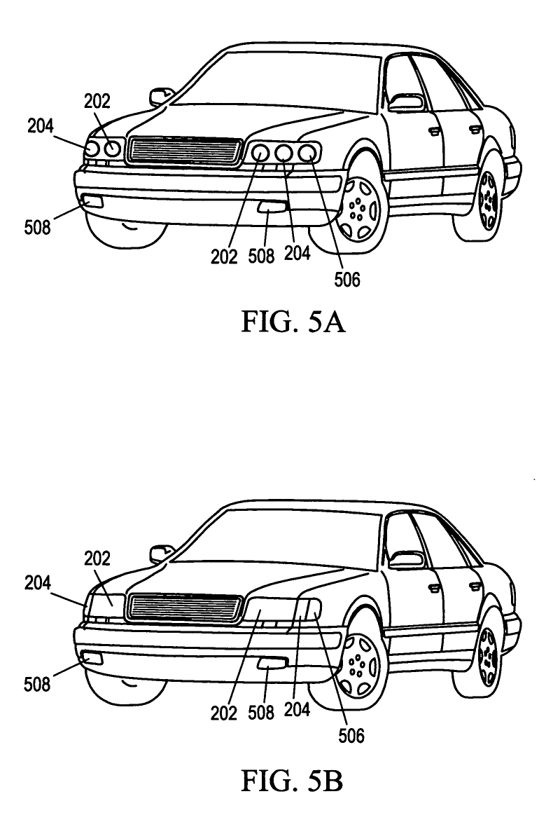

With reference to FIG. 5A, in one embodiment, a forward mounted accelerator indicator 506 is an additional light which is added to a conventional headlamp or headlamp enclosure. Such additional indicator 506 is a light which is similar in size, shape and intensity as a conventional amber running light 204.

In another embodiment, an existing amber running light 204 may be used as a forward mounted accelerator indicator by attaching the running light 204 to a new logic circuit or device (not shown), and optionally changing the color of the running light 204. Such accelerator indicator light 506 is preferably visible from the side and front of a vehicle. Such accelerator indicator light 506 may be blue, aqua, green, yellow, orange, amber, magenta, cyan, silver, gold, mauve, lime, beige, or other color.

Alternatively, an accelerator indicator light apparatus may be mounted near a headlamp enclosure and a separate accelerator indicator light apparatus may be mounted on the side of the forward region of a vehicle. In another embodiment, an accelerator indicator 508 is a light mounted in the same or similar location as conventional fog lights which are generally located below the headlamps 202 in the front region of a motor vehicle.

In a further embodiment, and with reference to FIG. 5B, an accelerator indicator 506 is comprised of a separate housing, reflective shell, translucent lens, and a light bulb or other light element inserted into an electrical socket. Such separate unit is mounted near or next to an existing headlamp 202 or next to an existing side mounted amber running or turn signal indicator 204.

With reference to FIG. 5C, in an alternative embodiment, a forward mounted accelerator indicator 506 is mounted behind or near the windshield of the passenger compartment of a motor vehicle. Such indicator may be near the dashboard or near the roof of the vehicle. An accelerator indicator may be mounted adjacent to a forward mounted brake indicator (not shown). There may be one or multiple such indicators, either grouped or dispersed, over the front of a vehicle. Such external indicator is not visible to the driver or passengers of a vehicle, but is visible to observers to the front and front oblique directions relative to a vehicle.

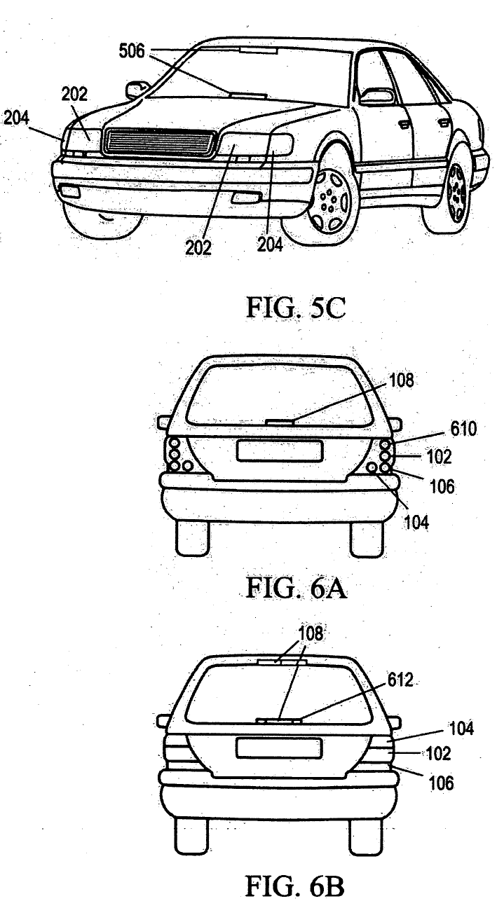

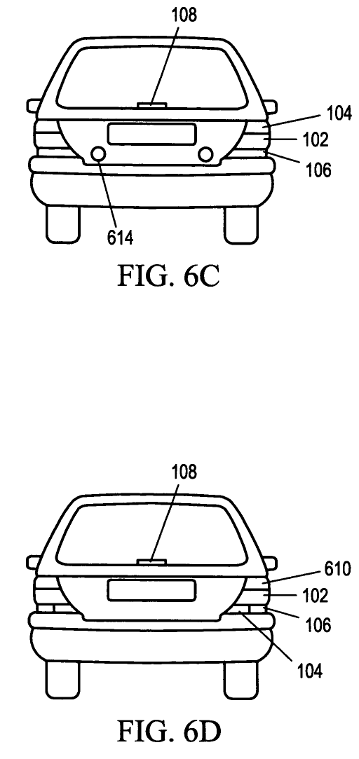

Accelerator indicators are also located on the rear of a motor vehicle. In one embodiment, and with reference to FIG. 6A, a rearward facing accelerator indicator 610 may be located in or near a conventional taillight assembly comprised of traditional brake lights 102, amber running and turn signal lights 104, and reverse drive lights 106. An additional socket, bulb, and optionally an additional reflector, an accelerator sensing device (not shown), and logic device (not shown) comprise the additional elements which are needed for such an accelerator indicator 610.

In another embodiment, no additional components are needed for a rear facing accelerator indicator. An accelerator indicator may comprise existing running or turn signal indicators 104 attached to a sensing device and logic device which are in turn attached to a vehicle's accelerator system. In such an embodiment, existing amber, orange or yellow running lights or turn signal indicators may be replaced by green or blue bulbs, lights, LED's, or lenses. Such an improved accelerator indicator would be one or more colors, and a brake indicator would be red.

In many vehicles, a rear center mounted brake light is located inside the back window of the passenger compartment. In another embodiment, and with reference to FIG. 6B, one or more rearward facing accelerator indicators 612 are located near the rear center mounted brake light. In one variation, an accelerator indicator is located directly on one or more sides of a rear center mounted brake light. In another variation (not shown), such indicator is mounted near the roof of a vehicle. In such a variation, a vehicle's center mounted brake indicator may also be so mounted. Such location would provide improved information about the operation of a vehicle, specifically the use, or disuse, of a vehicle's accelerator.

In another embodiment, and with reference to FIG. 6C, an accelerator indicator 614 is mounted in the trunk door of a motor vehicle. In another variation, an accelerator indicator is mounted in the bumper or bumper region of a vehicle. An accelerator indicator 614 comprises a light mounted inside its own housing and is electrically connected to the electrical system of the vehicle. In this embodiment, the accelerator indicator is not adjacent to any other light such as a license plate illuminator (not shown), rear brake light 102, amber running light or turn signal light 104, or reverse drive light 106.

In another embodiment, a rearward facing accelerator indicator is engaged or illuminated when a driver engages or uses a reverse drive in a vehicle. In another variation, all accelerator or brake indicators are engaged or actuated when a driver engages or uses a reverse drive.

In a further embodiment, and with reference to FIG. 6D, an accelerator indicator 610 is mounted adjacent to, but separately from, a rear tail light assembly. Such accelerator indicator 610 comprises a housing, a reflective shell, a socket, and a light emitting component such as, but not limited to, a light bulb. Such accelerator indicator 610 is covered by its own separate lens covering. Such lens covering may be clear, translucent, or colored.

Likewise, an accelerator indicator can have any suitable configuration as would be esthetically desirable for a particular model or style of motor vehicle. For example, in the embodiment illustrated in FIG. 5B, an accelerator indicator 506 is formed so as to conform to the shape of the corner of the vehicle, or an accelerator indicator 508 is formed so as to be of arbitrary shape and mounted in an arbitrary location such as in the same location as a traditional fog light.

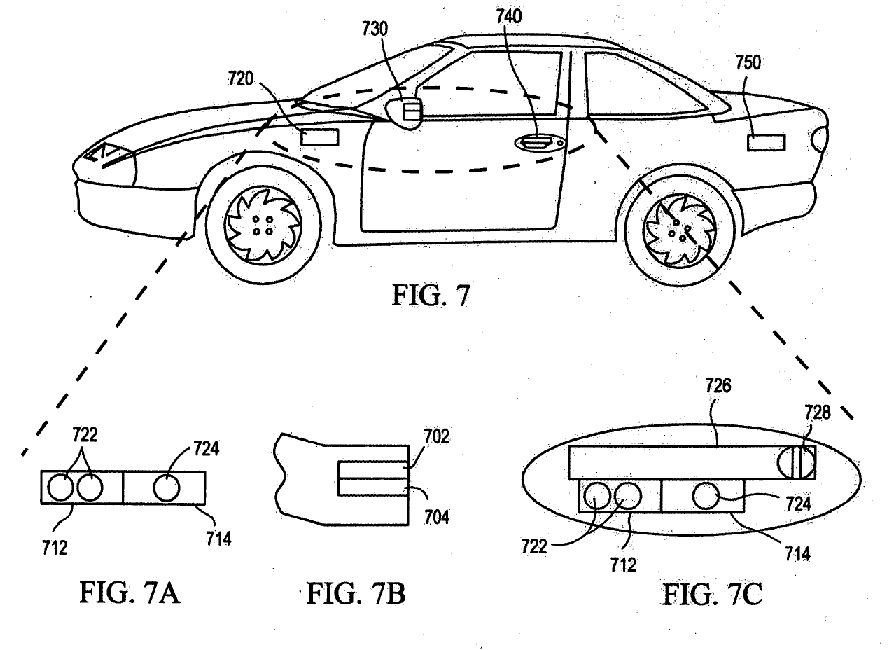

Accelerator and brake indicators according to the present invention may also be mounted at one or more places along the side of a vehicle. FIG. 7 shows a side view of a vehicle. With reference to FIG. 7, accelerator and brake indicators may be mounted on the side region near the front region 720 of a vehicle, on the side mounted rearview mirror 730, on or near the door handle 740, or on the rear region 750 of a vehicle. Such indicators are comprised of a housing, at least one light bulb or other light emitting element, at least one socket, and are connected electrically to the electric system of the vehicle. Side, forward and rear accelerator indicators may be of any color.

With reference to FIG. 7A, an indicator unit 720 is comprised of an accelerator indicator 712 and a brake indicator 714. An accelerator indicator 712 may be comprised of two light elements 722 which are capable of providing two or more stages of lighting such as a dim lighting state and a bright lighting state. In such an embodiment, one bulb or lighting element 722 is lit when the accelerator is engaged and the other element 722 is lit when the accelerator is not engaged. Alternatively, one single bulb or element may be manufactured so as to be emit light in varying states of intensity. In an alternative embodiment, one element 722 is lit when the accelerator is engaged and both elements 722 are lit when the accelerator is disengaged. A brake element 724 is lit when the brake is engaged, and is not lit when the brake is disengaged.

Likewise, with reference to FIG. 7C, an indicator unit 740 is comprised as in FIG. 7A but is located near, or is part of, a door handle unit. In such an embodiment, a door handle 726, a key lock 728, an accelerator indicator 712, and a brake indicator 714 comprise a door handle indicator unit. Such unit may have additional indicator functionality such as, but not limited to, illuminating or flashing one or more times upon receiving a signal from a keyless entry device, or illuminating or flashing continuously in a particular pattern upon receiving a signal from an auto theft detection component of the vehicle. Further, a door handle indicator unit may be illuminated continuously to facilitate entry into a vehicle.

In a similar embodiment, and with reference to FIG. 7B, a side indicator unit 730 is mounted to, and forms part of, a side mounted rearview mirror. Such a unit is comprised of an accelerator indicator 702 and a brake indicator 704. Such a unit may have additional functionality such as, but not limited to, illuminating or flashing as a turn signal. In one embodiment, both an accelerator indicator 702 and a brake indicator 704 form a turn indicator, and illuminate or flash brightly upon an action taken by a vehicle driver indicating that the vehicle driver is turning in a particular direction. An accelerator indicator, as part of such a side indicator unit 730, may have a dimly lit state and a brightly lit state as described previously. Such turn indicator may be comprised of any number of colors, and may flash or illuminate in a variety of different patterns or modalities indicating a turn.

Side, rear and forward mounted brake indicators, turn indicators, and accelerator indicators may be programmed to flash or illuminate to communicate one or more emergency states. A driver can actuate a control inside or outside a vehicle to illuminate one or a combination of brake and accelerator indicators. A pre-programmed sequence of illumination or flashing of such lights would communicate more effectively to viewers of an emergency state. In one embodiment, brake indicators would flash or illuminate with a red hue, and accelerator indicators would flash or illuminate with a blue hue.

Separate dashboard indicators communicate to a vehicle operator of the state or use of improved brake and accelerator indicators. In one embodiment, on the console or dashboard of a vehicle having an improved accelerator indicator, there is an indicator showing the use of such one or more external accelerator indicators. Further, there is optionally an indicator showing the use of one or more brake indicators. Alternatively, such console indicator shows the actual state of an external accelerator indicator. Also, such console indicator may also show the actual state of an external brake indicator. A console indicator may be used to show the states of accelerator engagement, accelerator disengagement, brake disengagement, brake engagement, and turn signal use.

In one embodiment of the present invention, a vehicle operator has the option of using just the forward and rearward accelerator indicators, or of using all available accelerator indicators. Likewise, a vehicle operator has the option of using just the forward and rearward brake indicators, or of using all available brake indicators. In such embodiments, a switch or other device may be used to select which mode a vehicle operator wishes to use. In one embodiment, a switch on a vehicle's dashboard allows an operator to select which mode to use.

In another embodiment, the response of a vehicle's accelerator and brake indicators depends upon the state of a vehicle's gears or gear switch. For example, when a vehicle is in park, a vehicle's accelerator indicators no longer respond to use of the vehicle's accelerator, and brake indicators are dimly or brightly lit. In another example, when a vehicle is in reverse, a vehicle's accelerator indicators are dimly lit, or brightly lit. In a further example, when a vehicle is in reverse, a vehicle's brake indicators are dimly lit, or brightly lit. In another example, an accelerator indicator is illuminated at one level while the vehicle is in one gear and illuminated at a second level while the vehicle is in another gear.

In another embodiment, brake indicators are given priority over accelerator indicators. For example, if an accelerator and brake are used simultaneously, the brake indicators are illuminated. In another example, an accelerator indicator is illuminated when it is engaged and a brake indicator is off, an accelerator indicator is extinguished and a brake indicator is dimly lit when the accelerator is disengaged, and a brake indicator is brightly lit when a brake is engaged. In yet another example, an accelerator indicator is brightly illuminated when the accelerator is engaged and a brake indicator is off, an accelerator indicator is dimly illuminated and a brake indicator is dimly lit when the accelerator is disengaged, and no accelerator indicator is illuminated and a brake indicator is brightly lit when a brake is engaged. In another example, an accelerator indicator is dimly illuminated when the accelerator is engaged and a brake indicator is off, an accelerator indicator is brightly illuminated and a brake indicator is dimly lit when the accelerator is disengaged, and no accelerator indicator is illuminated and a brake indicator is brightly lit when a brake is engaged.

In this invention, an accelerator indicator may be of any visible color. In one embodiment, a light bulb emits blue light which is defined as electromagnetic radiation in the visible spectrum having a wavelength of approximately 470 nm. Similarly, a light bulb emits green light at approximately 550 nm. However, in other embodiments, light is emitted at other frequencies which either combine to form blue or green light, respectively, or emanate through a colored lens thereby presenting a blue or green color, respectively. Blue or green light as used in this invention is not merely that color as strictly and conventionally used but encompasses other shades or variations at or near blue or green on an artist's color wheel, respectively.

Blue, as used for an accelerator indicator, is aesthetically pleasing and is nearly opposite to the red as used in conventional brake lights on an artist's color wheel. Blue light is one of the three primary additive colors along with red and green. Alternatively, an accelerator indicator may use a green hue. Blue is also chosen to complement traditional red and amber vehicle indicator lights. The perception of color is a biological phenomenon and is influenced by short-term effects such as the presence of nearby colors. Light for an accelerator indicator may be generated by any means. Light may be generated directly, e.g. from a light emitting bulb, or it may be generated by a filter or colored translucent lens mounted over a device emitting light at one or more other frequencies. In this invention, a brake indicator and accelerator indicator may emit radiation at a higher or lower frequency than visible light.

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described herein and above is further intended to explain the best mode presently known of practicing the invention and to enable others skilled in the art to utilize the invention as such, or in other embodiments, and with the various modifications required by their particular application or uses of the invention. It is intended that the appended claims be construed to include alternate embodiments to the extent permitted.

I claim:

1. A vehicle having an improved signaling system comprising:
(a) a brake indicator; and
(b) an accelerator indicator, wherein the accelerator indicator has at least a first and second intensity.

2. The vehicle of claim 1 wherein the accelerator indicator comprises a bulb having a lens.

3. The vehicle of claim 2 wherein the bulb has a hue.

4. The vehicle of claim 2 wherein the lens has a hue.

5. The vehicle of claim 1 wherein the brake indicator comprises a bulb having a lens.

6. The vehicle of claim 5 wherein the bulb has a hue.

7. The vehicle of claim 5 wherein the lens has a hue.

8. The vehicle of claim 1 wherein the accelerator indicator comprises a light source.

9. The vehicle of claim 8 wherein the light source is a bulb.

10. The vehicle of claim 8 wherein the light source is an LED.

11. The vehicle of claim 8 wherein the light source is a laser.

12. The vehicle of claim 8 wherein the light source is a LCD.

13. The vehicle of claim 1 wherein the brake indicator comprises a light source. .

14. The vehicle of claim 13 wherein the light source is a bulb.

15. The vehicle of claim 13 wherein the light source is an LED.

16. The vehicle of claim 13 wherein the light source is a laser.

17. The vehicle of claim 13 wherein the light source is a LCD.

18. The vehicle of claim 1 further comprises:
(c) a control circuit to illuminate the accelerator indicator at a first intensity when a vehicle is coasting.

19. The vehicle of claim 1 further comprises:
(c) a control circuit to illuminate the accelerator indicator at a first intensity when a vehicle is accelerating.

20. The vehicle of claim 1 further comprises:
(c) a control circuit to illuminate the accelerator indicator at a second intensity when a vehicle is coasting.

21. The vehicle of claim 1 further comprises:
(c) a control circuit to illuminate the accelerator indicator at a second intensity when a vehicle is accelerating.

22. The vehicle of claim 1 further comprises:
(c) means to illuminate the brake indicator at a first and second intensity.

23. The vehicle of claim 22 wherein the means to illuminate further comprises a control circuit to illuminate the brake indicator at least a first intensity when the vehicle is coasting.

24. The vehicle of claim 22 wherein the means to illuminate further comprises a control circuit to illuminate the brake indicator at a first intensity when the vehicle is accelerating.

25. The vehicle of claim 22 wherein the means to illuminate further comprises a control circuit to illuminate the brake indicator at a second intensity when the vehicle is braking.

26. The vehicle of claim 1 wherein the accelerator indicator is located on a rear surface of the vehicle.

27. The vehicle of claim 1 wherein the accelerator indicator is located on a front surface of the vehicle.

28. The vehicle of claim 1 wherein the accelerator indicator is located on a side surface of the vehicle.

29. The vehicle of claim 1 wherein the accelerator indicator is located on a top surface of the vehicle.

30. The vehicle of claim 1 wherein the brake indicator is located on a rear surface of the vehicle.

31. The vehicle of claim 1 wherein the brake indicator is located on a front surface of the vehicle.

32. The vehicle of claim 1 wherein the brake indicator is located on a side surface of the vehicle.

33. The vehicle of claim 1 wherein the brake indicator is located on a top surface of the vehicle.

34. The vehicle of claim 1 wherein the accelerator indicator is illuminated at an intensity based on a gear of the transmission.

35. The vehicle of claim 1 wherein the indicator lights are triggered by a driver controlled input in a vehicle cabin.

36. The vehicle of claim 1 further comprises an indicator status to inform the driver of the status of the indicators.

37. The vehicle of claim 1 wherein the accelerator indicator further comprises a turn indicator.

38. The vehicle of claim 1 wherein the accelerator indicator and brake indicator further comprise a turn indicator.

39. A method of improving driver safety by signaling the use of a brake or an accelerator in a vehicle comprising the steps of:
(a) illuminating a brake indicator upon the use of the brakes; and
(b) illuminating an accelerator indicator upon the use of the accelerator, wherein the accelerator indicator has a first and a second intensity.

40. The method of claim 39 further comprises illuminating the accelerator indicator at a first intensity level when the vehicle is coasting.

41. The method of claim 39 further comprises illuminating the accelerator indicator at a second intensity level when the vehicle is accelerating.

42. The method of claim 39 wherein the first intensity is less illuminating than the second intensity.

43. The method of claim 39 further comprises illuminating the accelerator indicator if the accelerator is active for greater than a predetermined amount of time.

44. The method of claim 39 further comprises blinking the accelerator indicator.

45. The apparatus of claim 39 wherein said vehicle light apparatus is illuminated dependent upon the state of a vehicle's gear switch.
